(19) United States
(12) Patent Application Publication
(10) Pub. No.: US 2025/0021880 A1
(43) Pub. Date: Jan. 16, 2025

(54) ACCELERATED DEEP ACTIVE LEARNING WITH GRAPH-BASED SUB-SAMPLING

(71) Applicant: Nokia Solutions and Networks Oy, Espoo (FI)

(72) Inventors: Dan Kushnir, Maplewood, NJ (US); Shiyun Xu, Jersey City, NJ (US)

(21) Appl. No.: 18/767,837

(22) Filed: Jul. 9, 2024

Related U.S. Application Data
(60) Provisional application No. 63/512,972, filed on Jul. 11, 2023.

(51) Int. Cl. G06N 20/00

(52) U.S. Cl. CPC G06N 20/00

(57) ABSTRACT

In some embodiments, there is provided receiving, as an input to a first machine learning model, a plurality of data; learning, by the first machine learning model and based at least on the plurality of data, a latent space; generating, based on the plurality of data and the latent space, a proximity graph, wherein label knowledge from labeled data is diffused on a plurality of nodes of the proximity graph; filtering, by the proximity graph, the plurality of nodes to provide a top k most uncertain nodes, wherein the top k most uncertain nodes form a subset of a plurality of unlabeled data; and providing the subset of the plurality of unlabeled data to a second machine learning model comprised in an active learning process. Related system, methods, and articles of manufacture are also disclosed.

### CROSS-REFERENCE TO RELATED APPLICATION

The present application claims priority to U.S. Provisional Application No. 63/512,972 filed Jul. 11, 2023, and entitled “ACCELERATED DEEP ACTIVE LEARNING WITH GRAPH-BASED SUB-SAMPLING,” and incorporates its disclosure herein by reference in its entirety.

### FIELD

The subject matter described herein relates to making machine learning more efficient by reducing the computing resources associated with active learning.

### BACKGROUND

Machine learning (ML) models may learn via training. The ML model may take a variety of forms, such as an artificial neural network (or neural network, for short), decision trees, and/or the like. The training of the ML model may be supervised (with labeled training data), semi-supervised, or unsupervised. When trained, the ML model may be used to perform a task, such as an inference task.

### SUMMARY

In some embodiments, there is provided receiving, as an input to a first machine learning model, a plurality of data; learning, by the first machine learning model and based at least on the plurality of data, a latent space; generating, based on the plurality of data and the latent space, a proximity graph, wherein label knowledge from labeled data is diffused on a plurality of nodes of the proximity graph; filtering, by the proximity graph, the plurality of nodes to provide a top k most uncertain nodes, wherein the top k most uncertain nodes form a subset of a plurality of unlabeled data; and providing the subset of the plurality of unlabeled data to a second machine learning model comprised in an active learning process. Related system, methods, and articles of manufacture are also disclosed.

In some variations, one or more of the features disclosed herein including the following features can optionally be included in any feasible combination. The first machine learning model may include a variational auto encoder including an encoder and a decoder, wherein the encoder is coupled to an encoder input to receive the plurality of data and an encoder output provides the latent space, and wherein a decoder output reproduces a representation of the input. Each node of the proximity graph corresponds to a data sample from an unlabeled pool or from a labeled training set. The latent space is a lower order dimension when compared to a dimension of the input of the first machine learning model or an output of the first machine learning model. The proximity graph includes at least one edge coupling at least a pair of nodes, wherein the label knowledge is diffused based on a similarity metric between at least the pair of nodes. The filtering further may include ranking, based on uncertainty of the diffused labels, the plurality of nodes of the proximity graph from a high uncertainty value to a low uncertainty value and in response to the ranking, selecting the top k most uncertain nodes, wherein the top k most uncertain nodes are associated with magnitudes of diffused labels. The second machine learning model outputs at least a portion of the subset of the unlabeled data toward an oracle to label the portion of the subset of the unlabeled data. The second machine learning model includes a decoder of a variational auto encoder. There may also be provided updating the label knowledge with one or more additional labels for at least a portion of the subset of the unlabeled data, wherein the updated label knowledge is diffused among the plurality of nodes of the proximity graph; filtering, by the proximity graph and based on the updated label knowledge, the plurality of nodes to provide an updated top k most uncertain nodes, wherein the updated top k most uncertain nodes form an updated subset of the unlabeled data; and providing the updated subset to the second machine learning model comprised in the active learning process.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1A depicts an example of an active learning process, in accordance with some embodiments;

FIG. 1B depicts an example system including a latent graph diffusion, in accordance with some embodiments;

FIGS. 1C, 1D, and 1E depict examples of diffusion via a graph, in accordance with some example embodiments;

FIG. 2 depicts an example of an active learning process including the latent graph diffusion, in accordance with some embodiments;

FIG. 3 depicts an example of a process for active learning including the latent graph diffusion, in accordance with some embodiments;

FIG. 4 depicts an example of a process for general active learning, in accordance with some embodiments;

FIG. 5 depicts an example of a process for general active learning using the latent graph diffusion, in accordance with some embodiments;

FIG. 6 depicts a plot of a two-dimensional (2D) projection of images into a VAE latent space of a machine learning model representations of the digits “4” and “9”, in accordance with some embodiments;

FIG. 7 depicts a plot of the exploration-refinement of a graph diffusion-based data sampling of ML model representations of digits the “4” and “9”, in accordance with some embodiments;

FIG. 8 depicts a plot showing sample selection and refinement of decision boundaries between clusters of different classes, in accordance with some embodiments;

FIG. 9 depicts an example of an ML model, in accordance with some embodiments; and

FIG. 10 depicts an example of a computing system, in accordance with some embodiments.

Like labels are used to refer to same or similar items in the drawings.

### DETAILED DESCRIPTION

Machine learning (ML) and, in particular, deep learning provides unprecedented performance in various semi-supervised learning tasks including speech recognition, computer vision, natural language processing, and the like. And in the case of deep Convolutional Neural Networks (CNN), the deep CNNs can recognize objects (in some cases better that a human). The success of ML comes with a need for massive amounts of labeled data to train the ML models used to perform a task, such as object recognition and the like. While data collection at a large scale may be considered relatively straight forward, the annotation of the collected data with labels is considered a bottleneck for successful ML training and execution.

Active learning may be used to select a set of data points for labeling to optimally minimize the error probability under a fixed budget of labeling effort. The phrase “active learning” refers to machine learning, in which a learning algorithm selectively queries an oracle (e.g., a user or an automated labeler) to selectively label the data. With active learning, the algorithm may proactively select a subset of data (also referred to as samples) to be labeled from a larger pool of unlabeled data. In this way, active learning may reduce the labeling effort needed from the oracle as part of training and developing ML models including semi-supervised ML models.

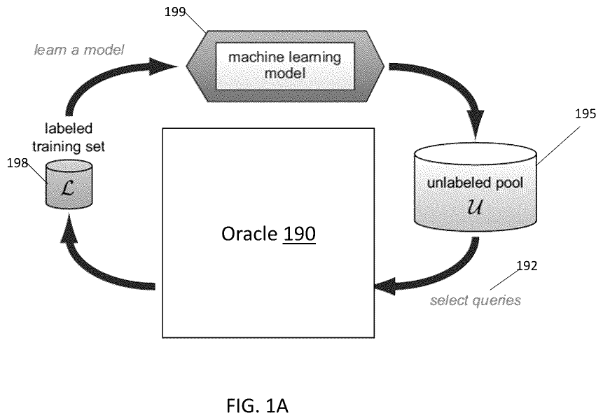

FIG. 1A depicts an example of a process for active learning. Referring to FIG. 1A, a machine learning model 199 may be trained (using a labeled training set 198) to perform a task to for example classify a data input and then, if classified with a threshold amount of certainty (or other metric, such as confidence, a similarity metric, and/or the like) apply a label to the data input. Even in the process of FIG. 1A, there can be a large unlabeled pool 195 of data that cannot be (or is not) labeled (e.g., due to more than a threshold amount of uncertainty regarding the classification of the item being labeled). And, the unlabeled pool of data (e.g., images, language, etc.) may be provided via a select query 192 to an oracle 190 (e.g., a labeler, such as a human annotator or an automated labeler) to provide a label for the corresponding unlabeled data.

Although the active learning of FIG. 1A can reduce the computational burden associated with labeling data, active learning itself can be computationally burdensome. With active learning, the selection query 192 should sample data from the unlabeled pool 195 in accordance with at least uncertainty (or, e.g., any other active learning criteria) and diversity sampling. With respect to uncertainty, the selection of data samples from the unlabeled pool 195 should improve the ML model 199 learning as rapidly as possible, while diversity sampling provides data heterogeneity in the feature space (where there can be natural clusters) to avoid sampling redundancy. Optimizing for uncertainty and/or diversity may require scanning all the data in the unlabeled pool 195 at least once, and can even include applying a methodology (having computational costs) that scales quadratically or more with the unlabeled pool size. An active learning cycle as depicted at FIG. 1A can repeat the time-consuming ML model 199 training and/or retraining as well as query selection process multiple times. In many cases, the repetitions render active learning extremely computational burden and, as such, impractical on a real, practical large unlabeled pool, such as the unlabeled pool 195 (which can include for example millions of images, for example).

In some embodiments, there are provided systems, articles of manufacture, and methods for selection of a restricted pool subset of unlabeled samples using latent graph diffusion.

In some embodiments, a graph, such as a proximity graph, is generated (e.g., computed, determined, etc.) once based on the latent space of a Variational Auto Encoder (VAE). The proximity graph includes nodes, each of which may correspond to a data sample in the pool of unlabeled data, such as unlabeled pool 195. And, the latent space (which includes labeling or classification knowledge) is used to diffuse (among the nodes of the proximity graph) possible, likely labels for the data samples of the unlabeled pool 195.

FIG. 1B depicts an example of a system 100 including a dataset 102, which in this example is unlabeled. For example, the dataset 102 includes unlabeled images, such as images of numbers (e.g., 4, 9, 5, and/or other types of images), although the dataset 102 may include some labeled data as well. Although some of the examples refer to the data as images, the data may be of other types (e.g., audio, speech, video, and/or any other type of data).

The system 100 also includes a machine learning (ML) model, such as a VAE 104. During learning, the VAE is trained using samples from the dataset 102 as inputs 106A. The unlabeled samples (which are selected from the dataset 102) are provided as an input 106A until the VAE learns to reproduce the input 106A at its output 106B. For example, the system 100 may iterate over a plurality of samples in the dataset 102 until the VAE learns to reproduce the input 106A at its output 106B. Although this example refers to the VAE receiving at the input 106A unlabeled samples from the dataset 102, the VAE may also receive one or more labeled data samples as well.

In some embodiments, the VAE 104 includes an encoder 108A and a decoder 108B, so during learning the encoder 108A encodes the input into a “latent” space 110, while the decoder 108B takes the encoded data (which is in the latent space or domain) and transforms it back into its original input form or domain. During training of the VAE 104, the encoder and decoder neural networks are optimized, such that if an unlabeled image “4” from the dataset 102 is provided as an input 106A, the encoder 108A encodes that input into the latent space 110 (e.g., “domain”), and the decoder 108B takes the encoded data and transforms it back into its original input form and provides it at the output 106B, which in this example would be a reproduced version of “4”. The training of the VAE may continue until the input 106A is reproduced at the output 106B with less than a threshold amount of mean squared error. Although the latent space is depicted at FIG. 110 as a lower dimensional space of 3 values, this is merely an example.

After training of the VAE 104, the latent space 110 may be used to generate a proximity graph 115 and, in particular, provide latent graph diffusion. The phrase “latent graph diffusion” refers to using the latest space 110 representation to build a proximity graph and then diffusing the label knowledge using weights on the proximity graph edges. The process of diffusion using the proximity graph is described further below.

The proximity graph 115 provides a structure where each node represents a sample in the dataset 102, and the nodes are connected via edges (e.g., links). FIG. 1C depicts a portion of the proximity graph 115. Node 155A is denoted as vᵢ and classified as for example “red” while the other nodes 155B-D are not classified as red but as additional labels are received (e.g., from data labeled by the oracle 190) diffusion continues to take place, and the other nodes 155B-D may begin to be considered more and more similar to node 155A as depicted at FIG. 1D. In other words, the proximity graph 115 provides a structure that allows label information from a training set to be used to assess whether a given node is likely similar in labeling to another node, in which case these similar nodes can be similarly labeled, for example. In addition, the proximity graph 115 also indicates which nodes are not similar to other nodes. The proximity graph 115 thus provides a structure that allows classification or label information to be diffused from one node to another node to assess the labels of unlabeled nodes. For example, nodes 156A and 156B at FIGS. 1C-1D may correspond to samples in the dataset 102 that are not similar to node 155A, so the label (or classification) of node 155A should not be associated with nodes 156A and 156B.

Referring again to FIG. 1B, the latent space 110 is used for label diffusion to learn to classify an input and provide a label. And in the example of FIG. 1B, this label knowledge (contained in the latent space) is used via diffusion among the nodes of the proximity graph. For example, if the latent diffusion graph 115 learns to label different images as “4” and “9” and so forth, the latent graph diffusion can be used to diffuse the label classification knowledge to a pool of images (each image represents a node in the proximity graph. Moreover, the diffusion through the nodes may indicate the level of uncertainty the model has on the class assignment of a sample by following the magnitude of the diffused label of a node. In some embodiments, the proximity graph provides a predetermined quantity of data samples corresponding to nodes that cannot be labeled or classified via diffusion with high certainty. Given for example a budget of k images (e.g., 500 images), the proximity graph 115 may output at 120 the top k images (which cannot be labeled with high certainty). These top k images are output at 120 as candidates for a query to the oracle 190 for labeling.

FIG. 1E depicts another example of the proximity graph 115. In the example of FIG. 11A, the nodes are shown at 152A-E. The proximity graph includes at least one edge coupling at least a pair of nodes, such that the label knowledge is diffused based on a similarity metric between at least the pair of nodes. For example, each of the nodes 152A-E represent different data (also referred to herein as samples, members, or data elements) in a dataset, such as the dataset 102. As noted, the data in the dataset may include unlabeled data, although labeled data may be included in the dataset 102 as well (so the nodes of the proximity data may correspond to unlabeled and labeled data samples as well). The edge (e.g., line coupling two nodes) is added to a proximity graph at FIG. 1E when at least one of the two nodes is close in the latent space (e.g., at least one of the nodes is the K-closest nodes to the other node). For example, the proximity graph 115 includes an edge between nodes Xᵢ and Xⱼ if Xⱼ is one of the K-closest nodes to Xᵢ, or if Xᵢ is one of the K-closest nodes to Xⱼ. To illustrate further, the edge that links X₁ and X₂ indicates that X₁ is the K-closest node to X₂ (or X₂ is the K-closest node to X₁). In this example, K is a preselected threshold, such as 1, 2, 3, 4, 5, and or other value. Moreover, each edge may be assigned a weight (e.g., ω₁₂, ω₁₃, etc.) that corresponds to an amount of similarity between the nodes coupled by the edge. For example, each edge between a pair of nodes (i, j) is assigned a weight that represents a similarity, such as a similarity metric wᵢⱼ (e.g., a distance measurement in the latent space) between the node values. The initial edge weights ωᵢⱼ may be computed as exp (−(|Xᵢ−Xⱼ|\hat{ }2)/σ₁), wherein σ₁ is a predefined (e.g., user defined or assigned in other ways) parameter that may depend on Xᵢ and Xⱼ. The ωᵢⱼ may be normalized to

$${w}_{ij} = \frac{ω ij}{{\sum }_{j} ω ij}$$

to form a weight for the edge. In the example of FIG. 1E, there is no edge shown between the node 152B and node 152E as neither node is one of the K-closest nodes to the other node. Diluting edges in this manner may reduce the processing time without penalty because there is not enough similarity between the nodes 152B and 152E to consider the edge between them for the diffusion of labels. Referring again to FIG. 1B, the proximity graph 115 may be used to diffuse labels (from training or labeled data) to nodes in the proximity graph 115. This label knowledge diffusion (also referred to as propagation) among the nodes may be done, such that the certainty of a diffused label from one node to another may be based on the magnitude of the weighted labels that has been propagated to it 115. Although FIG. 1B is used to describe an example of diffusion of labels through the proximity graph, other techniques may be used to diffuse the labeling knowledge to the nodes of the proximity graph. For example, U.S. Pat. No. 9,269,055, entitled “Data classifier using proximity graphs, edge weights, and propagation labels (which is incorporated herein in its entirety) explains an example technique for diffusion of label classification or knowledge through the nodes of a proximity graph.

Referring to FIG. 1B, the system 100 in operation uses a dataset (e.g., the dataset 102 which includes unlabeled data, although labeled data may be included as well) and the VAE 104 to generate the proximity graph 115, with latent space diffusion to the nodes (“latent graph diffusion”). After the graph 115 is generated, and diffusion is conducted (e.g., labels from labeled data is diffused among the nodes), the graph 115 can be used to select a subset (e.g., top k samples with respect to uncertainty of labeling) from the pool of unlabeled data 102. This subset serves as the candidate data 120 for the selected query toward the oracle 190. In other words, the graph 115 is used to identify a predetermined number of nodes, such as the top k nodes with respect to node uncertainty of classification (or labeling). In this example, a threshold quantity of nodes may be selected that are highly uncertain about their diffused label assignment. Once ranked by the uncertainty level of their label assignment for example, the k top uncertain nodes may be selected and output at 120. For example, k may be selected based on a computational or resource budget, so assuming a k of 500, the top 500 most uncertain images may be output a 120 from a larger unlabeled data sample pool of for example 5 million samples. In this way, the system 100 may reduce the amount of data using the fast diffusion-based method which need to be processed during active learning from the large set of unlabeled samples in the dataset 102 to a smaller, sub-set output at 120. To illustrate with another example, the node for the image for “4” may be in the dataset 102, and may correspond to a node of the graph 115 with a high uncertainty value, so the node for the image “4” cannot be labeled with confidence via diffusion. In this example, the image “4” may be output at 120 as part of the top k uncertain nodes or images.

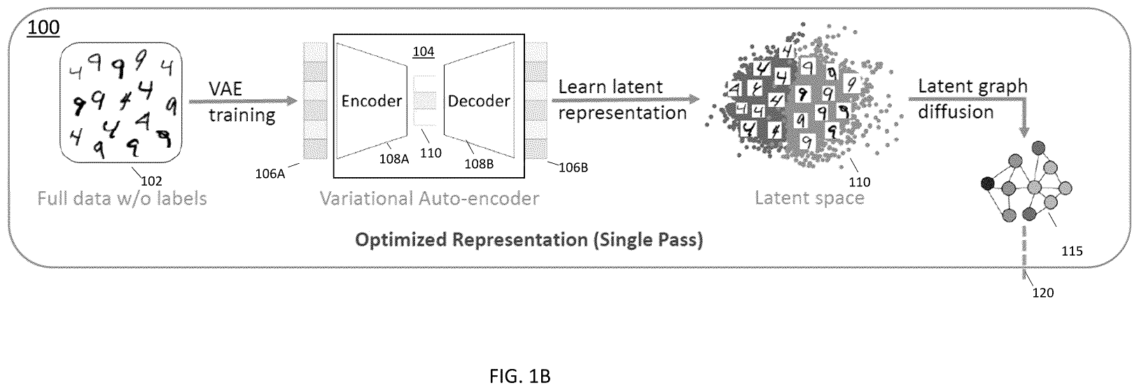

FIG. 2 depicts a system 200 for active learning, in accordance with some embodiments. The system 200 for active learning includes a labeled training set 210 used to learning (e.g., train, re-train, etc.) a machine learning (ML) model 212A-B configured to perform a task, such as classify (e.g., determine labels for) unlabeled data, such as the unlabeled dataset 102. The ML model 212B outputs at 220 one or more candidate queries (which may contain or indicate one or more data samples for labeling) toward the oracle 190 for labeling.

In the example of FIG. 2, the proximity graph 115 provides candidate data 120 (for the label query) as an input into the ML model 212B, which is configured to then select from the subset provided at 120 the one or more candidate queries 220 toward the oracle 190. Rather than provide the entire unlabeled dataset 102 to the ML model 212B, the unlabeled pool dataset 102 is essentially “filtered” to a subset of candidate samples. Specifically, the graph 115 may be used to select a subset, such as the top k images with respect to labeling uncertainty.

Given for example an unlabeled dataset 102 of 10 million images, the graph 115 may output the top 500 (where k=500) images with respect to labeling. In this example, the 500 nodes (which correspond to unlabeled images from the pool dataset 102) are the most uncertain nodes with respect to their label assignment, as such, labeling by the oracle 190 should be performed. The top 500 images output at 120 are provided as an input to a second machine learning model, such as the ML model 212B for further classification or label processing as part of active learning. In this example, the ML model 212B may (or may not) be able to label some of the top 500 images. For the images that cannot be classified by the ML model 212B, these unlabeled images are output at 220 by the ML model 212B and sent toward the oracle for a label query at 220. In this way, the proximity graph 115 with the diffusion of labels is able to reduce the resources needed by the ML model 212B e.g., from 5 million images to the top 500 in this example). The subset at 120 may also reduce the overall candidate samples at 220 for labeling by the oracle 190, so the overall compute resources needed by the ML model 212B are reduced (which also decreases the ML learning time and decreases overall query times to the oracle 190).

After the oracle 190 labels some of the candidate samples provided at 220, these annotated samples are provided at 225 to the labeled training set 210. The labeled training set may be used to re-train at 230 the ML model 212A-B to determine labels for samples. Moreover, the additional training data may be used by the proximity graph 115 to further learn by diffusing classification knowledge with respect to labels among the nodes of the proximity graph 115. In other words, the structure of the proximity graph 115 does not changes but the diffusion of label information among nodes may be updated or change, so the certainty or uncertainty associated with labels for some of the nodes (which represent data samples in the dataset 102) may also change or be updated at 240. As noted with the example of FIGS. 1C and 1D, the additional label knowledge (as a result of re-training and the select query to the oracle 190) may be diffused, such that the uncertainty of remaining unlabeled nodes may change as well. With the re-training of the ML model 212A and 212B and additional diffusion at the proximity graph 115, the active learning process can repeat with another iteration, so the unlabeled dataset 102 is again processed through the proximity graph 115 (with the label knowledge diffused among the nodes) to identify the top k nodes with respect to uncertainty. And, these top k candidates are provided at 120 as an input into the ML model 212B, which is configured to then process the subset provided at 120 and output one or more candidate queries 220 containing data samples from the unlabeled dataset 102 that are selected based on a second selection criterion from the model 212B As the active learning iterates, the structure of the proximity graph 115 (which represents the nodes of the unlabeled dataset 102, for example) may not change but additional knowledge regarding labeling may be used via diffusion in the proximity graph 115 to generate additional top k candidates at 120. As noted, the diffusion at the proximity graph is a process of propagating label knowledges (e.g., weighted labels) from node to another node. If the training set (which initially have the true labels) is changing as we query more data and label it, the propagation of labels on the proximity graph 115 changes to reflect the added information from the labeling of new nodes.

Referring again to FIG. 1B, the process is comprised of at least two aspects: a representation process in which VAE 104 training may occur once and used to generate a proximity graph 115 representation that is then shared in the iterative stage of FIG. 2 for the active learning process. As noted, the same proximity graph 115 structure can be used throughout the active learning iterations of FIG. 2B to generate a small set of candidates that are fed into a ML model 212A-B (e.g., a classification neural network) for the final query selection candidates 220 (via criteria such as uncertainty sampling, margin, etc.).

The graph-based diffusion of the labels via graph 115 used at FIG. 1B may enhance important criterion in active learning referred to as the exploration-exploitation (or exploration-refinement criterion). Exploration addresses a stage in active learning in which data is sampled and annotated to first map decision boundaries in the data. On the other hand, exploitation takes the so far detected boundaries and samples points around it to better localize it. At early stages of active learning, an exploratory strategy may yield better gains in accuracy over boundary refinement ones. Once all boundaries are detected however, a refinement stage may provide better accuracy gains over further exploration. This is a trade-off not leveraged in some active learning criteria, such as probabilistic uncertainty sampling or diversification per-se. In particular, a query selection criterion of k-nearest neighbors to the training set also does not reflect this trade-off.

In some implementations, the diffusions of labels using the proximity graph to “filter” candidate unlabeled data samples from a pool of samples may improve active learning query time and scales to large scale datasets.

In some embodiments, a graph-based diffusion process is used to restrict or filter the candidate samples in a pool of unlabeled samples to a smaller, sub-set of candidate samples, such that smaller sub-set is used in an active learning process (which is more efficiently performed as a result of the smaller, sub-set of candidate samples). In some implementations, the active learning process using the graph-based diffusion process may accelerate the query time, when compare dot other active learning schemes.

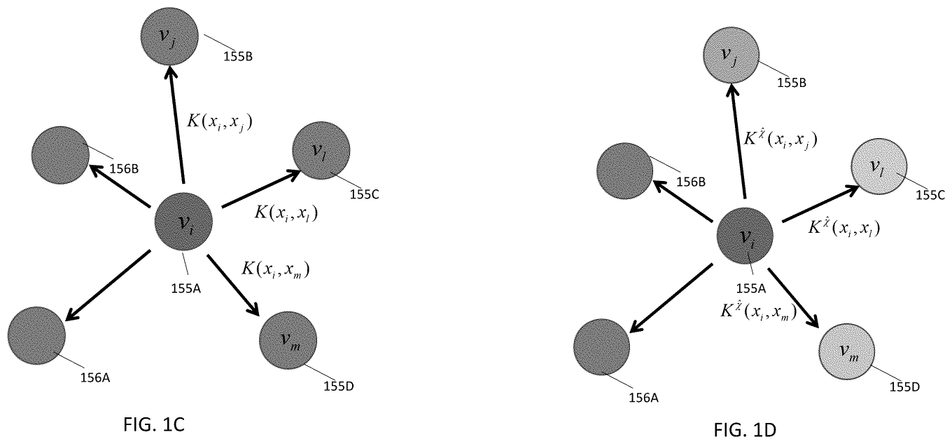

FIG. 3 depicts an example process for active learning using graph-based sub-sampling, in accordance with some embodiments.

At 302, the process may include receiving, as an input to a first machine learning model, a plurality of data, in accordance with some embodiments. For example, a first machine learning model, such as the VAE 104 depicted at FIG. 1B, may receive at an encoder input 108A a plurality of data, such as images or other types of data. The plurality of data may be from a pool of unlabeled data samples, such as unlabeled dataset 102, and/or from a training set of labeled data samples which may be obtained from labeled training set 210 or from sone other dataset. In this example, the first machine learning model is a variational auto encoder that includes an encoder 108A and a decoder 108B.

At 304, the process may include learning, by the first machine learning model and based at least on the plurality of data, a latent space, in accordance with some embodiments. For example, the first machine learning model, such as VAE 104, may learn to reproduce the input images provide at the encoder input 108A at the decoder output 106B. In this example, the encoder output provides the latent space 110. When the learning learns the reproduction to within a threshold mean squared error, the latent space 110 may be used as a data representation because the latent space may provide structure correlated with the labeling knowledge. Alternatively, or additionally, the learning by the machine learning model may, as noted, include one or more labeled data samples as well. In the example of FIG. 1B, the latent space 110 is a lower order dimension when compared to the dimensionality of the input 106A or output 106B, although this is merely an example as other dimensionalities may be associated with the encoder input, latent space, and decoder output.

At 306, the process may include generating, based on the plurality of data and the latent space, a proximity graph, wherein label knowledge from labeled data is diffused among a plurality of nodes of the proximity graph, in accordance with some embodiments. For example, a proximity graph, such as proximity graph 115, may be generated, such that the data samples received as an input at 106A are represented by nodes connected by edges. The nodes may correspond to data samples obtained from for example an unlabeled pool of data samples, such as dataset 102. Alternatively, or additionally, one or more of the nodes may comprise labeled data obtained from for example a labeled training set, such as labeled training set 210 (some of which may include training data classified by the oracle or labeled autonomously by the active learning). The label knowledge obtained from the training data may be diffused among the nodes of the proximity graph. The label knowledge can be diffused and the uncertainty (or, e.g., certainty) of this diffusion among the nodes may be used to select a subset of the nodes.

At 308, the process may include filtering, by the proximity graph, the plurality of nodes to provide a top k most uncertain nodes, wherein the top k most uncertain nodes form a subset of a plurality of unlabeled data, in accordance with some embodiments. For example, the proximity graph may be used to filter (e.g., sub-sample) the nodes, such that the k most uncertain nodes are selected and form a subset of the unlabeled data, which is provided to the second machine learning model 212B. In an implementation, the plurality of nodes of the proximity graph may be ranked from a high uncertainty value to a low uncertainty value. In response to the ranking for example, the top k most uncertain nodes (with respect to labeling) may be selected.

At 310, the process may include providing the subset of the plurality of unlabeled data to a second machine learning model comprised in an active learning process, in accordance with some embodiments. For example, the subset of the unlabeled data, such as images and/or the like, may be output at 120 towards an active learning process. In the example of FIG. 2, the second machine learning model comprises the decoder 212B of a VAE, so the decoder 212B further processes subset of the unlabeled data, and when the decoder 212B cannot classify the subset of the unlabeled data, those unlabeled images are sent as a query at 220 towards the oracle for labeling.

As noted, the active learning of FIG. 2 may yield additional label knowledge (e.g., due to the oracle 190 or the ML model 212A-212B. For example, at least a portion of the subset of the unlabeled data at 120 may result in one or more additional labels. The additional label knowledge may be diffused among the plurality of nodes of the proximity graph 115. When this is the case, the proximity graph 115 (now updated with the updated label knowledge) may output at an updated top k most uncertain nodes, wherein the updated top k most uncertain nodes form an updated subset of the unlabeled data that is provided at 120 to the second machine learning model 212B, such as a neural network or a deep neural network.

The following provides additional description with respect to semi-supervised learning, active learning, diffusion, and other related aspects.

Graph-based semi-supervised learning (GSSL) refers to a machine learning that exploits the information of both the labeled and unlabeled datasets to learn a good classifier for unlabeled samples. As a form of semi-supervised learning, active learning automates the process of data acquisition from a large pool of unlabeled dataset for annotation, which may achieve a certain performance of the classifier. GSSL (which is a type of semi-supervised learning) aims to present the data in a graph, such that the label information of the unlabeled set can be inferred using the labeled data. For example, label propagation or Laplace learning may be used. With label propagation, label information is diffused from a labeled set to unlabeled instance. Moreover, the computation complexity of label propagation may be characterized as linear in the size of the data. The success of label propagation hinges on an informative graph that retains similarity of the data points. Due to the volatile property of image pixels (e.g., unstable to noise, rotation, etc.) feature transformations may be applied to build good quality graphs, and variational auto-encoders may be used to generate high-quality latent representation of data for feature extraction and similarity graph construction.

With respect to generative models in active learning, deep generative models may be used to learn the latent representation of data in both semi-supervised learning and unsupervised. Except for constructing similarity graph in graph-based semi-supervised learning, generative models in active learning may also be used to generate adversarial data/models for more efficient and robust active learning. For example, a task-agnostic generative model may be used to trains an adversarial network to select unlabeled instances that are distinct from the labeled set in the latent space of a variational auto-encoder (VAE).

First, consider a dataset D in R^{d} of cardinally [n] m, wherein R^{d} is the space of all real vectors in dimension d, its standard notation The dataset D can split into a labeled set Dₗ (which represents a labeled subset of D) and an unlabeled subset Dᵤ. C denotes the number of classes. Fixing a batch size of B, the most “informative” subset D* is sought for annotation from an unlabeled pool set given a limited budget for annotation.

With respect to active learning, let f_{θ} be a classifier where we assume data are sampled for example independently and identically distributed over a space D×[C], denoting [symbol] ·P_{z}. And, as the subset D* is sought,

$${min}_{{D}^{′} : \vert {D}^{′} \vert < B} {𝔼}_{x , y ∈ {D}^{′}} [ 𝕀 \{ {arg max}_{c ∈ [ C ]} {f}_{c} ( x ) \neq y \} ]$$

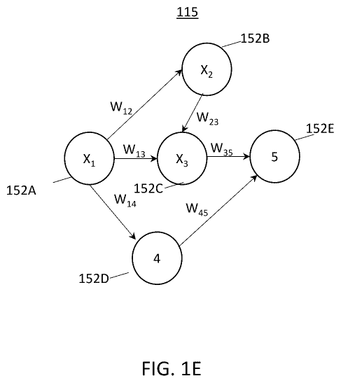

gives a minimum expected error. FIG. 4 depicts pseudo code for a multi-step active learning referred to as Algorithm 1.

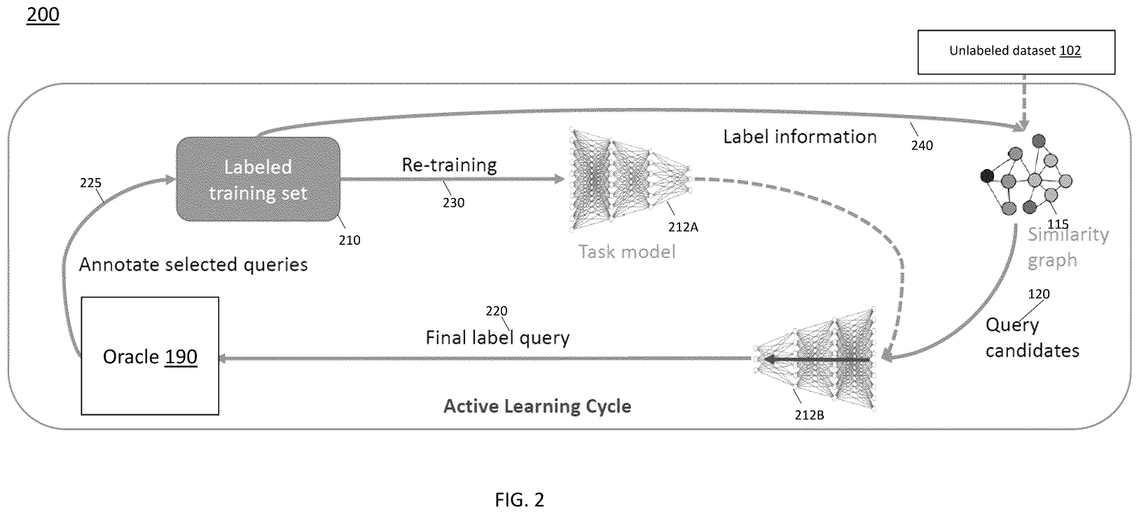

Algorithm 1 (which is depicted at FIG. 4) illustrate a way to perform active learning. But unlike Algorithm 1, an active criterion is being used at FIGS. 1B and 2 twice: first, a very efficient graph-diffusion-based selection criterion in the VAE latent space is used to restrict the pool set to a much smaller set of candidates; and second, a second criterion is used to select from the set of query candidates the final query set for annotation. This second selection criterion can be computationally intensive, however, but when applied to a smaller set can be executed extremely fast. An example of pseudo code for active learning with respect to FIGS. 1B and 2 (that includes the active criterion being used twice) is depicted at FIG. 5 as Algorithm 2. In Algorithm 2, the input includes the labeled and unlabeled pool set, the VAE architecture, and the task classification network f_{θ}. After training the representation model g start the active learning cycles that entails diffusion-based selection for restricting the pool set, feeding the restricted set to the task network f_{θ}, and using a baseline active learning criterion to select the final set; and after augmenting the training set with the final set, f_{θ} is trained again and the process repeats.

Although some of the examples refer to a latent space using the VAE-latent representation space, other latent spaces may be used. The VAE-latent representation space may provide an advantage as the VAE-latent representation space is derived via an unsupervised method which requires no labels, and can be performed only once, prior to label acquisition. The underlying assumption is that the representation space bears structure that correlates with the class function, and therefore can be used to restrict the pool set to a smaller, yet, useful set of candidates.

### VAE-Based Data Representation

Latent variable models, such as the VAE, learn representations of data, such as images. The VAE may be considered a generative neural network including a probabilistic encoder q(z|x) and a generative model p(x|z). The generator models a distribution over the input data x, conditioned on a latent variable z with prior distribution p_{θ}(z). The encoder approximates the posterior distribution p(z|x) of the latent variables z given input data x and is trained along with the generative model by maximizing the evidence lower bound (ELBO):

$$ELBO ( x ) = {E}_{q ( z \vert x )} [ log ( p ( x \vert z ) ] - KL ( q ( z \vert x ) ‖ p ( z ) )$$

where KL is the Kullback-Libeler divergence and log(p(x))≥ELBO(x).

To get a representative latent space from data (without label information), a ML model, such as a CNN, a deep CNN (e.g., ResNet18), and/or the like, may be used. For example, a ML model (e.g., ResNet18) based encoder may be used for large datasets. and a CNN-based VAE for all other datasets. In the first term,

$${E}_{q ( z \vert x )} [ log ( p ( x \vert z ) ] = \frac{1}{n} {\sum }_{i}^{n} {( {x}_{i} - {x}_{i}^{′} )}^{2} ,$$

where xᵢ^{l} is the i-th (out of n) reconstructed image. The mean squared error (MSE) loss may be used for the first term (e.g., reconstruction loss). Next, a proximity graph is considered from the latent representation to be used within a graph diffusion process and label acquisition.

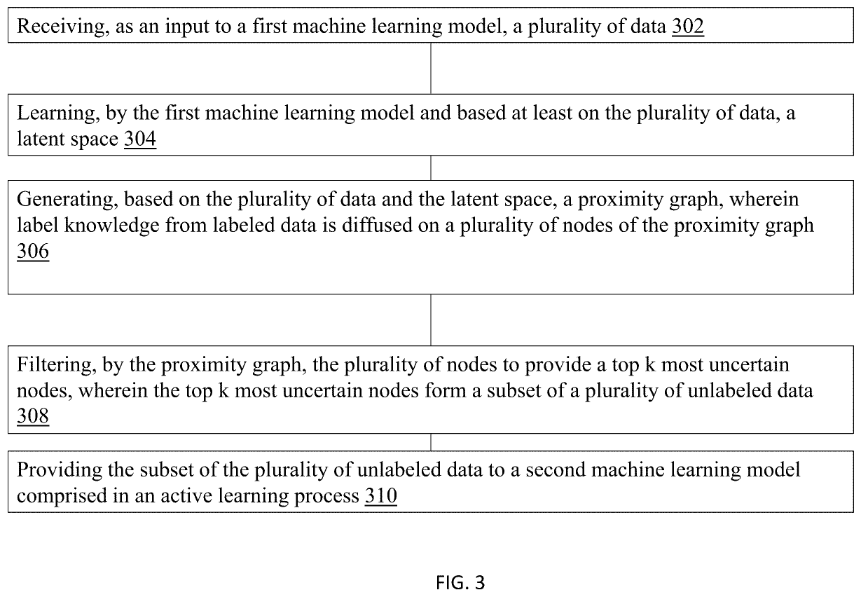

FIG. 6 visualizes a two-dimensional (2D) projection of a CNN-VAE 5D representation of digits “4” and “9” from for example the MNIST dataset. To demonstrate the important semantics of this representation for active learning, the decision boundary is between digits. For example, samples of “4”'s that are similar to samples from “9” class along the boundary.

### Diffusion on Graphs

The optimized latent representation, such as the latent space 110 learned by the VAE 104, to construct a k-nearest neighbor (KNN) based weighted proximity graph G=(V, E), wherein

$${W}_{ij} = m ( - \frac{ρ ( {z}_{i} , {z}_{j}}{{σ}_{ij}} ) 𝕀 \{ j ∉ N ( i ) \}$$

with m as a similarity metric, ρ as a distance metric, σᵢⱼ as a local scaling factor, and N(i) as the K-NN neighborhood of node i in the latent space g(D)=Z for encoder g, such as encoder 108A. A graph transition matrix P=T⁻¹W may be defined to stand for the transition probabilities of a Markov random walk on the proximity graph G. The matrix T is a diagonal where Tᵢᵢ=Σⱼ Wᵢⱼ.

The diffusion of labels in the proximity graph may be considered as a stochastic process, such as a Markov process that is used to propagate the label information of Dl to Du (e.g., from on node to another node). The transition probability of one step between state i and j can be denoted as Pij. Consider a binary classification, the classification probability P(y(zi)=1|zi) is associated with Pt(y(z)=1|i). A label is assigned to zi in Zu on this proximity graph G after a t-step random walk. Now, let Xᵢ=2Pt(y(z)=1|i)−1∈[−1, 1]. The signal of X stands for the binary class. Denote

$$T = ( \begin{matrix}{T}_{ll} & 0 \\ 0 & {T}_{uu}\end{matrix} ) , W = ( \begin{matrix}{W}_{ll} & {W}_{lu} \\ {W}_{ul} & {W}_{uu}\end{matrix} )$$

In matrix form

$${𝒳}_{u} = [ {T}_{uu}^{- 1} {W}_{ul} \vert {T}_{uu}^{- 1} {W}_{uu} ] ( \begin{matrix}{𝒳}_{l} \\ {𝒳}_{u}\end{matrix} ) .$$

Let the graph Laplacian L=D−W in the system, then

$${L}_{uu} {𝒳}_{u} = {W}_{ul} {𝒳}_{l} ⟺ {L}_{uu} {𝒳}_{uu} = - {L}_{ul} {y}_{l} \qquad ( 1 )$$

Equation (1) above can be solved via iteration:

$${𝒳}_{i}^{( t + 1 )} = \frac{1}{{L}_{uu , ij}} ( - {( {L}_{ul} {y}_{l} )}_{i} - {\sum }_{j \neq i} {L}_{uu , ij} {𝒳}_{j}^{( t )} ) . \qquad ( 2 )$$

And, Equation (2) transduces a label χᵢⁱ⁺¹ to Xᵢ as a weighted average of the labels of its neighbors with the transition weights. The diffusion process initializes with

$${𝒳}_{ic}^{( 0 )} = \{ \begin{matrix}1 & if {z}_{i} ∈ {Z}_{l} and c = {y}_{i} \\ - 1 & if {z}_{i} ∈ {Z}_{l} and c \neq {y}_{i} \\ 0 & if {z}_{i} ∈ {Z}_{u}\end{matrix} .$$

The labels are propagated to Xᵤ gradually for t steps. At the t-th step,

$${𝒳}_{ic}^{( t )} = \{ \begin{matrix}1 & if {z}_{i} ∈ {Z}_{l} and c = {y}_{i} \\ - 1 & if {z}_{i} ∈ {Z}_{l} and c \neq {y}_{i} \\ {( M {𝒳}_{: , c}^{( t - 1 )} )}_{i} & if {z}_{i} ∈ {Z}_{u}\end{matrix} .$$

### Query Criterion

The matrix χ^{(T)} of propagated values can be interpreted as uncertainties measured by the absolute value ∥χ_{c,i}^{(T)}∥. Specifically, the absolute value magnitude represents a measure of uncertainty on whether vertex i belongs to a class c. The magnitude can be used to select a new batch to query towards the oracle 190 as

$${D}_{sub}^{′} = \{ {x}_{i} : arg {min}_{{z}_{i} ∈ {Z}_{u}}^{B} {min}_{c ∈ [ C ]} ‖ {χ}_{c , i}^{( T )} ‖ \} , \qquad ( 3 )$$

where min^{B} denotes the B smallest elements. The selection criterion in Equation (3) depends on the initialization strategy used.

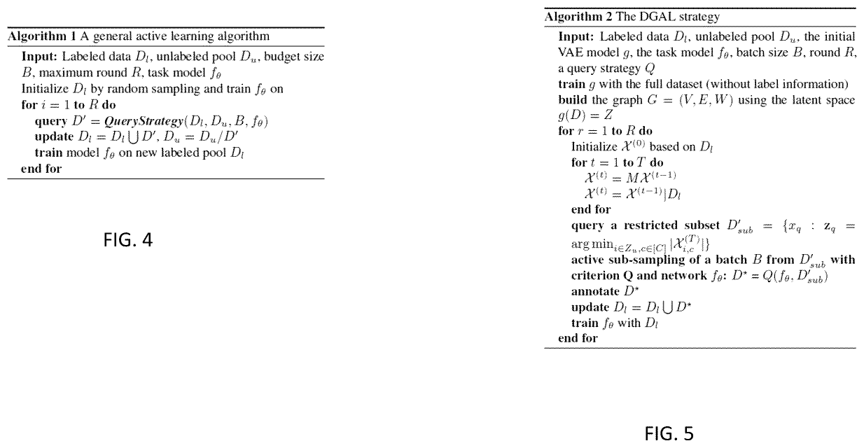

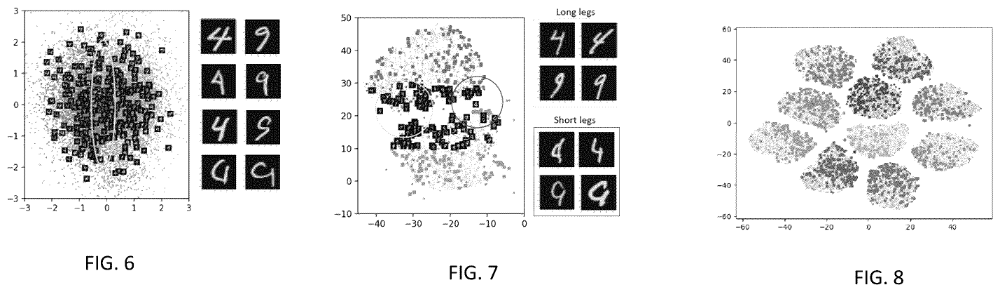

FIG. 7 shows the exploration-refinement with a subset of MNIST data representations in a trained ResNet18. Higher query rate is observed close to the decision boundary after the overall clusters have been explored (queried samples are in bold round points). The query selection along the boundary captures “4”s and “9”s that have similar shape and leg size and orientation. These samples whose similarity can be best learned via annotation are selected by the disclosed methods for annotation. A similar trend is captured in FIG. 8 for a CIFAR 10 data set showing the sample selection tends to the refinement of decision boundaries between clusters of different classes.

With respect to exploration and refinement, the query criterion (see, e.g., Equation (3)) coupled with the diffusion process allows exploration of the dataset at early stages of active learning and the switching to refinement when exploration has saturated. To understand this mechanism, we show in the following that the diffusion iterant χ^{t} converges to the second eigenvector ϕ₂ of the graph's Laplacian as t→∞. Asymptotically ϕ₂ provides a relaxed solution to the minimal normalized cut problem, where the cut corresponds to the decision boundary between the two classes in G (V, E, W). At early stages of label acquisition low magnitude entries in χ correspond to data points that are unreachable from the training set via diffusion and need to be explored. At later stages all unlabeled data points Xᵤ are reachable via diffusion from the labeled set Xₗ. At this stage low magnitude entries correspond to the transition between the two classes −1 and 1. These nodes capture the eigenvector's transition from negative to positive entries. Therefore, sampling these points corresponds to the refinement of the decision boundary.

### Deep Active Learning with the Task Classifier

Referring again to FIG. 2, a restricted subset D′sub is fed into the ML model 212B and using a baseline active learning criterion, the final set D* is sent at 220 for annotation. Clearly feeding pool data into the ML model 212 poses a significant computational cost. However, since the restricted set D′sub is significantly smaller than Du, a significant speedup in the query time can be achieved.

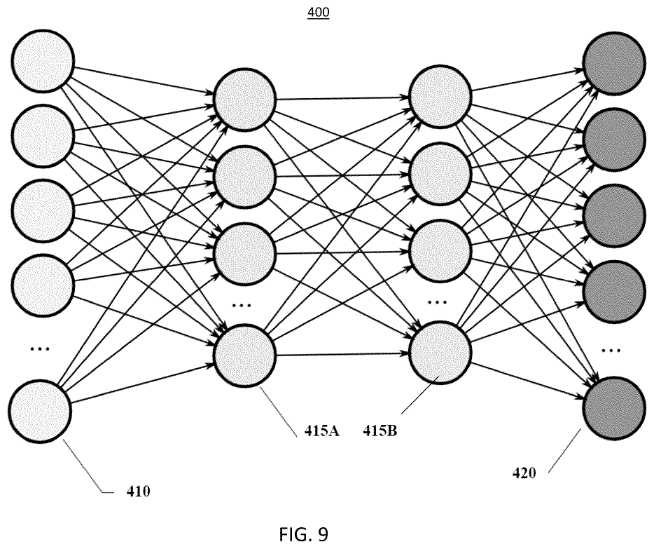

FIG. 9 depicts an example of a machine learning (ML) model 400, in accordance with some embodiments. For example, the ML model 400 (which in this example is a neural network) may be the same or similar to some if not all of the ML models disclosed herein. In the example of FIG. 9, the input layer 410 may include a node for each node in the network. The ML model may include one or more hidden layers 415A-B (also referred to as intermediate layers) and an output layer 420. The machine learning model 400 may be comprised in a network node, a user equipment, and/or other computer-based system. Alternatively, or additionally, the ML model may be provided as a service, such as a cloud service (accessible at a computing system such as a server via a network such as the Internet or other type of network). Although FIG. 9 depicts an example structure for a ML model, other types of ML models may be used as well.

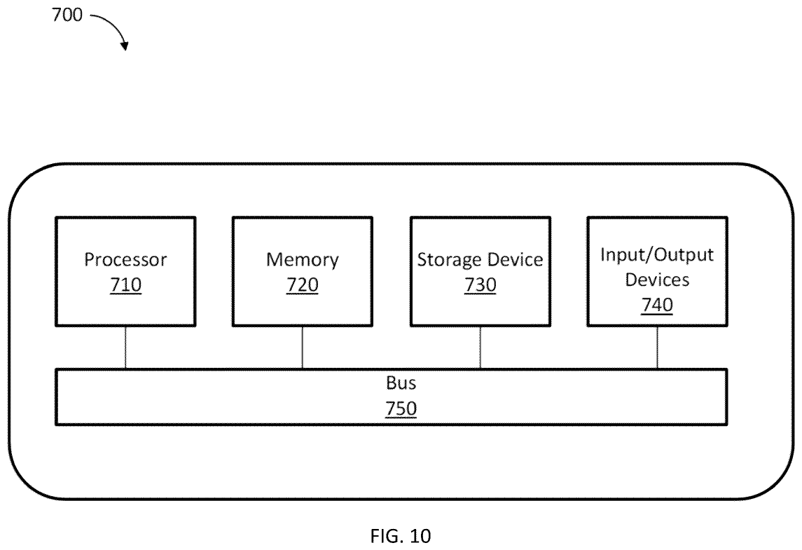

FIG. 10 depicts a block diagram illustrating a computing system 700, in accordance with some embodiments. For example, one or more of the aspects disclosed herein (see, e.g., FIG. 3, Algorithm 2, etc.) may be implemented using the system 700. As shown in FIG. 7, the computing system 700 can include a processor 710, a memory 720, a storage device 730, and input/output devices 740. The processor 710, the memory 720, the storage device 730, and the input/output devices 740 can be interconnected via a system bus 750. The processor 710 is capable of processing instructions for execution within the computing system 700. In some implementations of the current subject matter, the processor 710 can be a single-threaded processor. Alternately, the processor 710 can be a multi-threaded processor. The process may be a multi-core processor have a plurality or processors or a single core processor. Alternatively, or additionally, the processor 710 can be a graphics processor unit (GPU), an AI chip, and/or the like. The processor 710 is capable of processing instructions stored in the memory 720 and/or on the storage device 730 to display graphical information for a user interface provided via the input/output device 740. The memory 720 is a computer readable medium such as volatile or non-volatile that stores information within the computing system 700. The memory 720 can store data structures representing configuration object databases, for example. The storage device 730 is capable of providing persistent storage for the computing system 700. The storage device 730 can be a floppy disk device, a hard disk device, an optical disk device, or a tape device, or other suitable persistent storage means. The input/output device 740 provides input/output operations for the computing system 700. In some implementations of the current subject matter, the input/output device 740 includes a keyboard and/or pointing device. In various implementations, the input/output device 740 includes a display unit for displaying graphical user interfaces. According to some implementations of the current subject matter, the input/output device 740 can provide input/output operations for a network device. For example, the input/output device 740 can include Ethernet ports or other networking ports to communicate with one or more wired and/or wireless networks (e.g., a local area network (LAN), a wide area network (WAN), the Internet).

Without in any way limiting the scope, interpretation, or application of the claims appearing below, a technical effect of one or more of the example embodiments disclosed herein may include reduced use of compute resources during active learning.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

What is claimed:

1. A method comprising:
receiving, as an input to a first machine learning model, a plurality of data;
learning, by the first machine learning model and based at least on the plurality of data, a latent space;
generating, based on the plurality of data and the latent space, a proximity graph, wherein label knowledge from labeled data is diffused on a plurality of nodes of the proximity graph;
filtering, by the proximity graph, the plurality of nodes to provide a top k most uncertain nodes, wherein the top k most uncertain nodes form a subset of a plurality of unlabeled data; and
providing the subset of the plurality of unlabeled data to a second machine learning model comprised in an active learning process.

2. The method of claim 1, wherein the first machine learning model comprises a variational auto encoder including an encoder and a decoder, wherein the encoder is coupled to an encoder input to receive the plurality of data and an encoder output provides the latent space, and wherein a decoder output reproduces a representation of the input.

3. The method of claim 1, wherein each node of the proximity graph corresponds to a data sample from an unlabeled pool or from a labeled training set.

4. The method of claim 1, wherein the latent space is a lower order dimension when compared to a dimension of the input of the first machine learning model or an output of the first machine learning model.

5. The method of claim 1, wherein the proximity graph includes at least one edge coupling at least a pair of nodes, wherein the label knowledge is diffused based on a similarity metric between at least the pair of nodes.

6. The method of claim 1, wherein the filtering further comprises:
ranking, based on uncertainty of the diffused labels, the plurality of nodes of the proximity graph from a high uncertainty value to a low uncertainty value; and
in response to the ranking, selecting the top k most uncertain nodes, wherein the top k most uncertain nodes are associated with magnitudes of diffused labels.

7. The method of claim 1, wherein the second machine learning model outputs at least a portion of the subset of the unlabeled data toward an oracle to label the portion of the subset of the unlabeled data.

8. The method of claim 1, wherein the second machine learning model comprises a decoder of a variational auto encoder.

9. The method of claim 1 further comprising:
updating the label knowledge with one or more additional labels for at least a portion of the subset of the unlabeled data, wherein the updated label knowledge is diffused among the plurality of nodes of the proximity graph;
filtering, by the proximity graph and based on the updated label knowledge, the plurality of nodes to provide an updated top k most uncertain nodes, wherein the updated top k most uncertain nodes form an updated subset of the unlabeled data; and
providing the updated subset to the second machine learning model comprised in the active learning process.

10. An apparatus comprising:
at least one processor; and
at least one memory containing program code, which when executed by the at least one processor causes operations comprising:
receiving, as an input to a first machine learning model, a plurality of data;
learning, by the first machine learning model and based at least on the plurality of data, a latent space;
generating, based on the plurality of data and the latent space, a proximity graph, wherein label knowledge from labeled data is diffused on a plurality of nodes of the proximity graph;
filtering, by the proximity graph, the plurality of nodes to provide a top k most uncertain nodes, wherein the top k most uncertain nodes form a subset of a plurality of unlabeled data; and
providing the subset of the plurality of unlabeled data to a second machine learning model comprised in an active learning process.

11. The apparatus of claim 10, wherein the first machine learning model comprises a variational auto encoder including an encoder and a decoder, wherein the encoder is coupled to an encoder input to receive the plurality of data and an encoder output provides the latent space, and wherein a decoder output reproduces a representation of the input.

12. The apparatus of claim 10, wherein each node of the proximity graph corresponds to a data sample from an unlabeled pool or from a labeled training set.

13. The apparatus of claim 10, wherein the latent space is a lower order dimension when compared to a dimension of the input of the first machine learning model or an output of the first machine learning model.

14. The apparatus of claim 10, wherein the proximity graph includes at least one edge coupling at least a pair of nodes, wherein the label knowledge is diffused based on a similarity metric between at least the pair of nodes.

15. The apparatus of claim 10, wherein the filtering further comprises:
ranking, based on uncertainty of the diffused labels, the plurality of nodes of the proximity graph from a high uncertainty value to a low uncertainty value; and
in response to the ranking, selecting the top k most uncertain nodes, wherein the top k most uncertain nodes are associated magnitudes of the diffused labels.

16. The apparatus of claim 10, wherein the second machine learning model outputs at least a portion of the subset of the unlabeled data toward an oracle to label the portion of the subset of the unlabeled data.

17. The apparatus of claim 10, wherein the second machine learning model comprises a decoder of a variational auto encoder.

18. The apparatus of claim 10, further comprising:
updating the label knowledge with one or more additional labels for at least a portion of the subset of the unlabeled data, wherein the updated label knowledge is diffused among the plurality of nodes of the proximity graph;
filtering, by the proximity graph and based on the updated label knowledge, the plurality of nodes to provide an updated top k most uncertain nodes, wherein the updated top k most uncertain nodes form an updated subset of the unlabeled data; and
providing the updated subset to the second machine learning model comprised in the active learning process.

19. A non-transitory computer-readable storage medium including program code which when executed by at least one processor causes operations comprising:
receiving, as an input to a first machine learning model, a plurality of data;
learning, by the first machine learning model and based at least on the plurality of data, a latent space;
generating, based on the plurality of data and the latent space, a proximity graph, wherein label knowledge from labeled data is diffused on a plurality of nodes of the proximity graph;
filtering, by the proximity graph, the plurality of nodes to provide a top k most uncertain nodes, wherein the top k most uncertain nodes form a subset of a plurality of unlabeled data; and
providing the subset of the plurality of unlabeled data to a second machine learning model comprised in an active learning process.
